(19) United States
(12) Patent Application Publication
(10) Pub. No.: US 2015/0036891 A1
(43) Pub. Date: Feb. 5, 2015

(54) OBJECT VERIFICATION DEVICE, OBJECT VERIFICATION PROGRAM, AND OBJECT VERIFICATION METHOD

(71) Applicant: Panasonic Corporation, Osaka (JP)

(72) Inventors: Mariko Takenouchi, Osaka (JP); Saki Takakura, Osaka (JP)

(21) Appl. No.: 14/384,657

(22) PCT Filed: Mar. 13, 2013
(86) PCT No.: PCT/JP2013/001665

§ 371 Date: Sep. 11, 2014

(30) Foreign Application Priority Data
Mar. 13, 2012 (JP) 2012-056365

(51) Int. Cl. G06K 9/20; G06K 9/62

(52) U.S. Cl. CPC G06K 9/2018; G06K 9/2054; G06K 9/6201; G06K 9/2036
USPC 382/112

(57) ABSTRACT

There is provided an object verification device capable of detecting a fraudulent entry in an arbitrary area of an object without requiring a certification mark applied by a special material. An object verification device that verifies authenticity of an object includes: an image acquisition section that acquires an image of the object; a verification area identification section that identifies a verification area of the object for which authenticity is verified; an entry part detection section that detects a plurality of entry parts within the verification area in the image; and a verification section that verifies authenticity of the object by mutually comparing the plurality of entry parts in the image.

### CROSS REFERENCE TO RELATED APPLICATIONS

This application is based upon and claims the benefit of priority from prior Japanese Patent Application No. 2012-056365, filed Mar. 13, 2012, the entire content of which is incorporated herein by reference.

### TECHNICAL FIELD

The present invention relates to an object verification device, an object verification program, and an object verification method that verify authenticity of an object.

### BACKGROUND ART

There is conventionally known, as an object verification device that verifies authenticity of an object, a device that verifies authenticity of an object, such as a passport, marked with a predetermined mark made of a material (ink, etc.) that reflects ultraviolet ray. This object verification device acquires an ultraviolet image by photographing an object while irradiating the object with ultraviolet ray, identifies a type and a position of a pattern appearing on the ultraviolet image, and compares the identified type and position of the pattern with those of a reference pattern, thereby verifying authenticity of the object.

Further, as another example of the object verification device that verifies authenticity of an object, there is known a device that verifies authenticity of a driver's license based on a difference in reflectance or transmittance between a photograph area and an area outside the photograph generated when visible light is irradiated onto the driver's license (see, e.g., Patent Literature 1).

### CITATION LIST

### Patent Literature

Patent Literature 1: JP 2001-266206 A ✓

### SUMMARY OF INVENTION

### Technical Problem

However, the conventional object verification device using the ultraviolet image cannot verify an object that is not marked with a certification mark. Even for an authentic object that is marked with a certification mark, falsification made to an area outside the certification mark cannot be detected. Further, the conventional object verification device that verifies authenticity of the driver's license based on a difference in reflectance or transmittance between a photograph area and an area outside the photograph cannot detect falsification made to the area outside the photograph.

The present invention has been made in view of the above problems, and an object thereof is to provide an object verification device capable of detecting a fraudulent entry in an arbitrary area of the object without requiring a certification mark applied by a special material.

### Solution to Problem

A first aspect of an object verification device that verifies authenticity of an object, the device including: an image acquisition section that acquires an image of the object; a verification area identification section that identifies a verification area of the object for which authenticity is verified; an entry part detection section that detects a plurality of entry parts within the verification area in the image; and a verification section that verifies authenticity of the object by mutually comparing the plurality of entry parts in the image.

A second aspect of an object verification device that verifies authenticity of an object, the device including: a visible light image acquisition section that acquires a visible light image of the object; a non-visible light image acquisition section that acquires a non-visible light image of the object; a visible light image entry part detection section that detects, as a visible light image entry part, each of a plurality of entry parts of the object in the visible light image; a non-visible light image entry part detection section that detects, as a non-visible light image entry part, each of a plurality of entry parts of the object in the non-visible light image; and a verification section that verifies authenticity of the object by mutually comparing the plurality of detected visible light image entry parts and non-visible light image entry parts.

As described later, the present invention, the present invention has other aspects. Therefore, the disclosure of the present invention herein is not intended to limit the scope of the present invention described and claimed herein but to provide some of the aspects of the present invention.

### Advantageous Effects of Invention

According to the present invention, it is possible to detect a fraudulent entry in an arbitrary area of an object without requiring a certification mark applied by a special material.

### BRIEF DESCRIPTION OF DRAWINGS

FIG. 1 is a block diagram illustrating a configuration of an object verification device according to a first embodiment.

FIG. 2 is a view illustrating an object verification system including the object verification device according to an embodiment of the present invention.

FIG. 3 is a perspective view illustrating an entire configuration of an object reading device according to the embodiment.

FIG. 4 is a side view illustrating a main part inside the object reading device according to the embodiment.

FIG. 5 is a front view of an illumination board of the object reading device according to the embodiment, which illustrates arrangement of LED elements.

FIG. 6 is a view illustrating a concrete example of verification area information stored in a detection area information storage section of the object verification device according to a first embodiment.

FIG. 7A is a view illustrating a concrete example of a visible light image of an authentic driver's license in the first embodiment.

FIG. 7B is a view illustrating a concrete example of an infrared image of the authentic driver's license in the first embodiment.

FIG. 7C is a view illustrating a concrete example of an ultraviolet image of the authentic driver's license in the first embodiment.

FIG. 7D is a view illustrating a result obtained by detecting an entry part from the visible light image of the authentic driver's license in the first embodiment.

FIG. 7E is a view illustrating a result obtained by detecting the entry part from the infrared image of the authentic driver's license in the first embodiment.

FIG. 7F is a view illustrating a result obtained by detecting the entry part from the ultraviolet image of the authentic driver's license in the first embodiment.

FIG. 8A is a view illustrating a concrete example of a visible light image of a falsified driver's license in the first embodiment.

FIG. 8B is a view illustrating a concrete example of an infrared image of the falsified driver's license in the first embodiment.

FIG. 8C is a view illustrating a concrete example of an ultraviolet image of the falsified driver's license in the first embodiment.

FIG. 8D is a view illustrating a result obtained by detecting the entry part from the visible light image of the falsified driver's license in the first embodiment.

FIG. 8E is a view illustrating a result obtained by detecting the entry part from the infrared image of the falsified driver's license in the first embodiment.

FIG. 8F is a view illustrating a result obtained by detecting the entry part from the ultraviolet image of the falsified driver's license in the first embodiment.

FIG. 9 is a block diagram illustrating a configuration of an object verification device according to a second embodiment.

FIG. 10A is a view illustrating a concrete example of a visible light image of a falsified driver's license in the second embodiment.

FIG. 10B is a view illustrating a concrete example of an infrared image of the falsified driver's license in the second embodiment.

FIG. 10C is a view illustrating a concrete example of an ultraviolet image of the falsified driver's license in the second embodiment.

FIG. 10D is a view illustrating a result obtained by detecting the entry part from the visible light image of the falsified driver's license in the second embodiment.

FIG. 10E is a view illustrating a result obtained by detecting the entry part from the infrared image of the falsified driver's license in the second embodiment.

FIG. 10F is a view illustrating a result obtained by detecting the entry part from the ultraviolet image of the falsified driver's license in the second embodiment.

### DESCRIPTION OF EMBODIMENTS

Hereinafter, the present invention will be described in detail. Embodiments described herein are merely exemplary of the invention, which can be embodied in various forms. Thus, specific configurations and functions disclosed herein do not limit the scope of the claims of the present invention.

A first aspect of an object verification device that verifies authenticity of an object, the device including: an image acquisition section that acquires an image of the object; a verification area identification section that identifies a verification area of the object for which authenticity is verified; an entry part detection section that detects a plurality of entry parts within the verification area in the image; and a verification section that verifies authenticity of the object by mutually comparing the plurality of entry parts in the image.

With the above configuration, the plurality of entry parts in the verification area are mutually compared, and thus a fraudulently added entry part and an authentic entry part are mutually compared in the image of the object, so that it is possible to detect a fraudulent entry without requiring a certification mark applied by a special material. Further, the verification area is identified by the verification area identification section, so that the entry parts can mutually be compared for an arbitrary area of the object in which there may be a fraudulent entry. For example, a configuration is possible in which the plurality of entry parts are mutually compared for an area in which the unique information is entered, while the entry part in an area in which a fixed-form information is entered and entry part in an area in which the unique information are not mutually compared. The verification of authenticity of the object includes verification of presence/absence of a fraudulent entry in the object. That is, even if an object (e.g., driver's license, and passport, etc.) itself is authentic, the object is determined to be a forgery when there is a fraudulently added entry in the object. That is, “verification of authenticity” includes a concept of “verification (detection) of presence/absence of falsification”.

In the above object verification device, the image acquisition section may include a visible light image acquisition section that acquires a visible light image of the object and a non-visible light image acquisition section that acquires a non-visible light image of the object. The entry part detection section may detect the entry part from the visible light image, and the verification section may verify authenticity of the object by mutually comparing the plurality of entry parts in the non-visible light image.

With the above configuration, it is possible to determine that there is any fraudulent entry for a plurality of entry parts in the visible light image among which there seems to be no difference when viewed through human eyes when a difference occurs in the non-visible light image.

The above object verification device may further include a verification area information storage section that stores a unique area within the object in which unique information is entered. The verification area identification section may identify, as the verification area, the unique area stored in the verification area information storage section.

With the above configuration, for an object, such as a driver's license, in which an area in which fixed-form information is entered and an area in which unique information is entered are fixed, the area in which the unique information is entered can be stored as the verification area, so that it is possible to identify the verification area without a need for a user to specify the verification area.

The above object verification device may further include a verification area information storage section that stores a fixed-form area within the object in which fixed-form information is entered. The verification area identification section may identify, as the verification area, an area other than the fixed-form area stored in the verification area information storage section.

With the above configuration, for an object, such as a driver's license, in which an area in which fixed-form information is entered and an area in which unique information is entered are fixed, the area in which the fixed-form information is entered can be stored as a non-detection area, so that it is possible to identify the verification area without a need for a user to specify the verification area.

In the above object verification device, the verification section may verify authenticity of the object by comparing, between the plurality of detected entry parts, a luminance value of entry content in each entry part.

With the above configuration, it is possible to detect a fraudulent entry when the luminance differs between a fraudulently added entry content and an authentic entry content. Particularly, when the verification section uses the non-visible light image to compare the entry contents, a difference between the fraudulent entry and authentic entry, which cannot be detected through human eyes, can be detected.

In the above object verification device, the verification section may verify authenticity of the object by comparing, between the plurality of detected entry parts, a luminance difference between entry content and a background in each entry part.

With the above configuration, it is possible to detect a fraudulent entry when the luminance difference between the entry content and background differs between a fraudulently added entry content and an authentic entry content. Particularly, when the verification section uses the non-visible light image to compare the entry contents, a difference between the fraudulent entry and authentic entry, which cannot be detected through human eyes, can be detected.

In the above object verification device, the verification section may verify authenticity of the object by comparing, between the plurality of detected entry parts, a character font of entry content in each entry part.

With the above configuration, it is possible to detect a fraudulent entry when the character font differs between a fraudulently added entry content and an authentic entry content. In this case, the fraudulent entry can be detected using only, for example, the visible light image, that is, the image acquisition section need not acquire both the visible light image and non-visible light image.

A second aspect of an object verification device that verifies authenticity of an object, the device including: a visible light image acquisition section that acquires a visible light image of the object; a non-visible light image acquisition section that acquires a non-visible light image of the object; a visible light image entry part detection section that detects, as a visible light image entry part, each of a plurality of entry parts of the object in the visible light image; a non-visible light image entry part detection section that detects, as a non-visible light image entry part, each of a plurality of entry parts of the object in the non-visible light image; and a verification section that verifies authenticity of the object by mutually comparing the plurality of detected visible light image entry parts and non-visible light image entry parts.

With the above configuration, for the visible light image entry parts among which there seems to be no difference when viewed through human eyes, the entry part thereof may appear or not in the non-visible light image due to a difference in material (ink, etc.). Thus, by mutually comparing the plurality of visible light image entry parts and the plurality of non-visible light image entry parts as described above, it is possible to detect a fraudulent entry without requiring a certification mark applied by a special material.

The above object verification device may further include a verification area identification section that identifies a verification area of the object for which authenticity is verified. The visible light image entry part detection section may detect the plurality of visible light image entry parts in the identified verification area in the visible light image, and the non-visible light image entry part detection section may detect the plurality of visible light image entry parts in the identified verification area in the non-visible light image.

With the above configuration, it is possible to limit areas to be compared by the verification section to areas in which the unique information is entered, thereby improving accuracy of authentication verification.

In the above object verification device, the verification section may verify authenticity of the object by comparing a luminance difference between the visible light image entry part of the visible light image and non-visible light image entry part of the non-visible light image corresponding to the visible light image entry part for a plurality of combinations of the visible light image entry part and non-visible light image entry part.

With the above configuration, for the visible light image entry parts among which there seems to be no difference when viewed through human eyes, the entry part thereof may appear light or dark (or does not appear at all) due to a difference in material (ink, etc.). Thus, by mutually comparing the plurality of visible light image entry parts and the plurality of non-visible light image entry parts as described above, it is possible to detect a fraudulent entry without requiring a certification mark applied by a special material.

In the above object verification device, the verification section may verify authenticity of the object by comparing arrangement pattern of the plurality of visible light image entry parts of the visible light image and arrangement pattern of the plurality of non-visible light image entry parts of the non-visible light image.

With the above configuration, for the visible light image entry parts among which there seems to be no difference when viewed through human eyes, the entry part thereof may appear or not in the non-visible light image due to a difference in material (ink, etc.), with the result that an arrangement pattern of the plurality of visible light image entry parts in the visible light image and an arrangement pattern of the plurality of non-visible light image entry parts in the non-visible light image may differ from each other. Thus, by comparing the arrangement pattern, it is possible to detect a fraudulent entry without requiring a certification mark applied by a special material.

A first aspect of an object verification program allowing, when executed by a computer provided in an object verification device that verifies authenticity of an object to function as: an image acquisition section that acquires an image of the object; a verification area identification section that identifies a verification area of the object for which authenticity is verified; an image entry part detection section that detects, as an image entry part, each of a plurality of entry parts within the verification area in the image; and a verification section that verifies authenticity of the object by mutually comparing the plurality of detected image entry parts.

Also with the above configuration, the plurality of entry parts in the verification area are mutually compared, and thus a fraudulently added entry part and an authentic entry part are mutually compared in the image of the object, so that it is possible to detect a fraudulent entry without requiring a certification mark applied by a special material. Further, the verification area is identified by the verification area identification section, so that the entry parts can mutually be compared for an arbitrary area of the object in which there may be a fraudulent entry.

A second aspect of an object verification program allowing, when executed by a computer provided in an object verification device that verifies authenticity of an object to function as: an image acquisition section that acquires an image of the object; a verification area identification section that identifies a verification area of the object for which authenticity is verified; an image entry part detection section that detects, as an image entry part, each of a plurality of entry parts within the verification area in the image; and a verification section that verifies authenticity of the object by mutually comparing the plurality of detected image entry parts.

Also with the above configuration, for the visible light image entry parts among which there seems to be no difference when viewed through human eyes, the entry part thereof may appear or not in the non-visible light image due to a difference in material (ink, etc.). Thus, by mutually comparing the plurality of visible light image entry parts and plurality of non-visible light image entry parts as described above, it is possible to detect a fraudulent entry without requiring a certification mark applied by a special material.

A first aspect of an object verification method that verifies authenticity of an object, the method including: an image acquisition step of acquiring an image of the object; a verification area identification step of identifying a verification area of the object for which authenticity is verified; an image entry part detection step of detecting, as an image entry part, each of a plurality of entry parts within the verification area in the image; and a verification step of verifying authenticity of the object by mutually comparing the plurality of detected image entry parts.

Also with the above configuration, the plurality of entry parts in the verification area are mutually compared, and thus a fraudulently added entry part and an authentic entry part are mutually compared in the image of the object, so that it is possible to detect a fraudulent entry without requiring a certification mark applied by a special material. Further, the verification area is identified by the verification area identification step, so that the entry parts can mutually be compared for an arbitrary area of the object in which there may be a fraudulent entry.

An object verification method according to a second aspect is an object verification method that verifies authenticity of an object, the method including: a visible light image acquisition step of acquiring a visible light image of the object; a non-visible light image acquisition step of acquiring a non-visible light image of the object; a visible light image entry part detection step of detecting, as a visible light image entry part, an entry part in the visible light image; a non-visible light image entry part detection step of detecting, as a non-visible light image entry part, an entry part of the object in the non-visible light image; and a verification step of verifying authenticity of the object by mutually comparing the detected visible light image entry part and non-visible light image entry part.

Also with the above configuration, for the visible light image entry parts among which there seems to be no difference when viewed through human eyes, the entry part thereof may appear or not in the non-visible light image due to a difference in material (ink, etc.). Thus, by mutually comparing the plurality of visible light image entry parts and plurality of non-visible light image entry parts as described above, it is possible to detect a fraudulent entry without requiring a certification mark applied by a special material.

An object verification device will be described below with reference to the drawings. In the following description, a device that verifies a driver's license as the object to be verified; however, the object to be verified by the object verification device is not limited to the driver's license but may be any certificate.

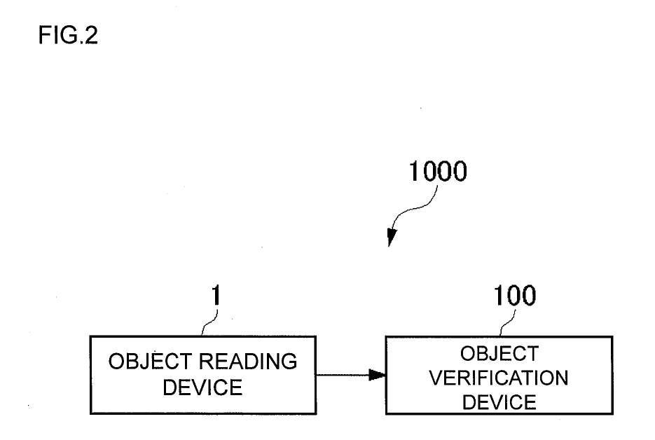

FIG. 2 is a view illustrating an object verification system including an object verification device according to embodiments. As illustrated in FIG. 2, an object verification device 100 is connected to an object reading device 1 through a Universal Serial Bus (USB) and constitutes, together with the object reading device 1, an object verification system 1000. The object reading device 1 reads a driver's license as an object to be verified and outputs a read image thereof to the object verification device 100. The object verification device 100 uses the read image to verify authenticity of the object to be verified. The object verification device 100 may be incorporated in the object reading device 1. Hereinafter, a configuration of the object reading device 1 will be described first, and then first and second embodiments of the object verification device will be described.

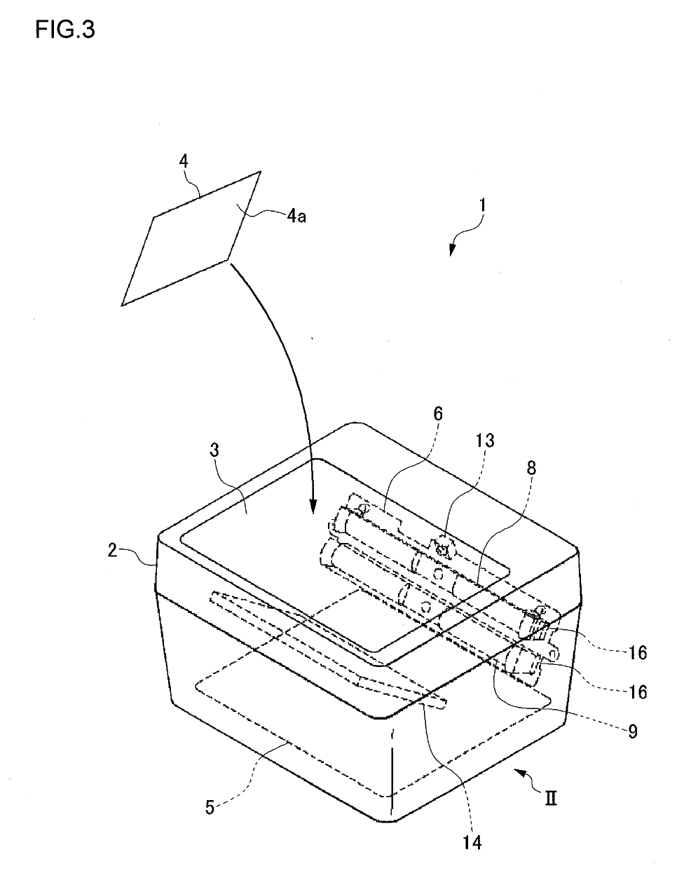

FIG. 3 is a perspective view illustrating an entire configuration of the object reading device of the embodiment. The object reading device 1 has a hollowed housing 2 with a substantially rectangular parallelepiped shape and used in a state of being placed on a desk or the like. The expression of vertical direction as used herein refers to the vertical direction in a state where the object reading device 1 is placed on the desk.

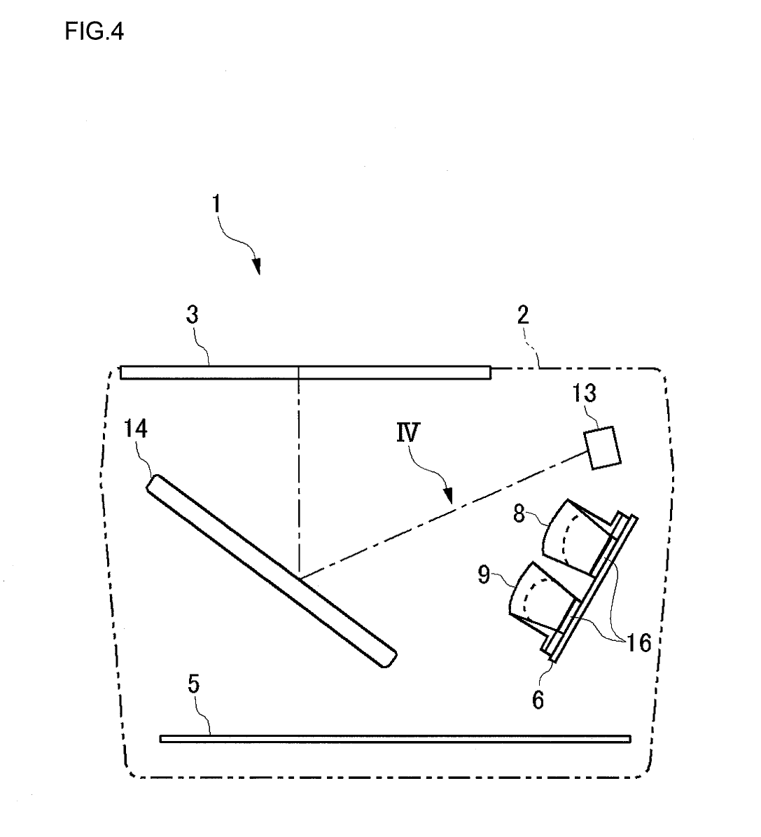

FIG. 4 is a side view illustrating a main part inside the object reading device according to the embodiment. As illustrated in FIG. 4, a glass plate 3 serving as a reading object placement portion is provided over generally the entire top surface of the housing 2. For example, a driver's license 4 which is an object to be verified is placed on an upper surface of the glass plate 3 with a surface 4a to be read thereof facing the glass plate 3. Inside the housing 2 and below the glass plate 3, a main board 5 is provided in the vicinity of a bottom surface of the housing 2. A control circuit, a drive circuit, and the like of the object reading device 1 are mounted on the main board 5. An illumination board 6 is provided above one end side of the main board 5. The illumination board 6 is inclined obliquely upward so as to face a rear surface of the glass plate 3.

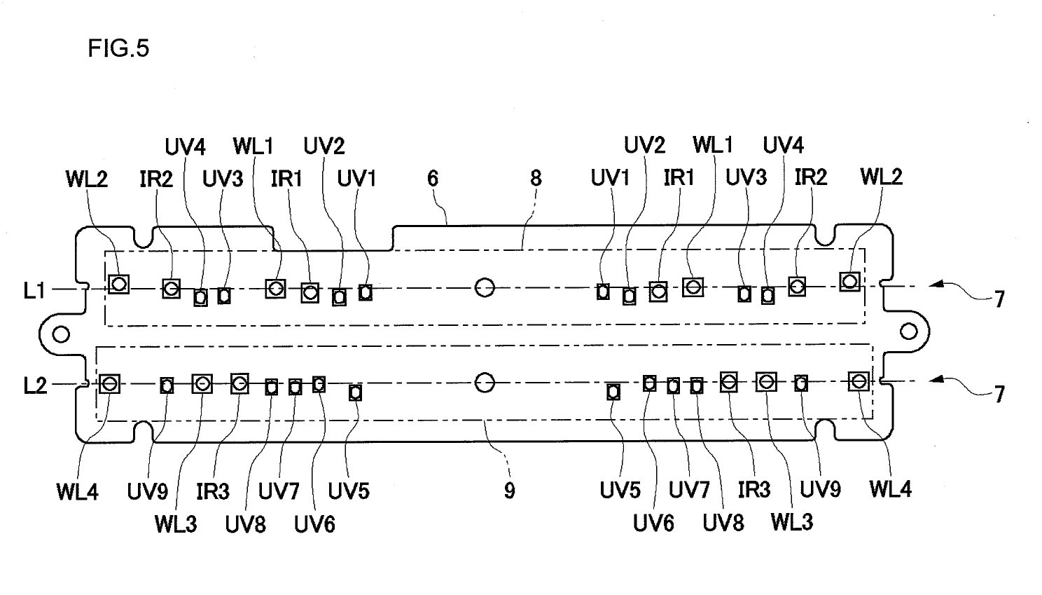

FIG. 5 is a front view of the illumination board of the object reading device according to the embodiment, which illustrates arrangement of LED elements. In FIG. 5, the illumination board 6 is viewed in a direction IV in FIG. 4. As illustrated in FIGS. 4 and 5, two vertically arranged LED arrays each including a plurality of LED elements as light-emitting elements are mounted on the illumination board 6, and rod-like light guide bodies (upper light guide body 8 and lower light guide body 9, which may be collectively referred to as “light guide bodies 8 and 9”) are provided so as to cover light emitting surfaces of the LED elements of the respective LED arrays 7 (in FIG. 5, light guide bodies 8 and 9 are each depicted in a long dashed double-short dashed line). Further, resin spacers 16 are disposed between the illumination board 6 and light guides 8 and 9, respectively. Each spacer 16 has opening portions corresponding respectively to the LED elements of each LED array 7 disposed on the illumination board 6. A wall surface of each opening portion of the spacer 16 has a tapered shape spreading in a light-emitting direction of the LED element. Light emitted from the LED element is reflected by this wall surface to be efficiently guided into the light guide bodies 8 and 9.

As illustrated in FIGS. 3 and 5, the upper light guide body 8 has a symmetrical shape with respect to a center portion in a longitudinal direction thereof and fixed to the illumination board 6 by screws passing through three mounting holes formed in the longitudinal direction center portion and longitudinal direction both end portions thereof, with the spacer 16 interposed therebetween and, similarly, the lower light guide body 9 has a symmetrical shape with respect to a center portion in a longitudinal direction thereof and fixed to the illumination board 6 by screws passing through three mounting holes formed in the longitudinal direction center portion and longitudinal direction both end portions thereof, with the spacer 16 interposed therebetween (mounting holes and screws are not illustrated). As described above, the light guide bodies 8 and 9 are each formed as an integrated member; however, the LED array 7 is not provided at a position on the illumination board 6 corresponding to the longitudinal direction center portion of each of the light guide bodies 8 and 9, and this portion does not have optical function, so that each of the light guide bodies 8 and 9 may be divided into two parts across the longitudinal direction center portion. This allows an electric component to be disposed on the illumination board 6 at a portion corresponding to the divided portion, thereby improving mounting efficiency of the illumination board 6.

As illustrated in FIGS. 3 and 4, a camera 13 serving as an image pickup device that picks up an image of the surface 4a to be read of the driver's license 4 placed on the upper surface of the glass plate 3 is provided at a position above the longitudinal direction center of the upper light guide body 8. Further, a reflecting mirror 14 for bending a light path of an image of the surface 4a to be read toward the camera 13 is provided at a position facing the camera 13. Bending the light path in this manner is effective for making the object reading device 1 compact.

FIG. 5 illustrates the arrangement of the LED elements of each LED array 7 mounted on the illumination board 6. At a portion corresponding to the upper light guide body 8, two ultraviolet LED elements UV1, UV2, an infrared LED element IR1, a white LED element WL1 for visible light, two ultraviolet LED elements UV3, UV4, an infrared LED element IR2, and a white LED element WL2 are arranged in the order mentioned from a center portion of the drawing to the right thereof along an upper side reference line L1 extending in the longitudinal direction of the upper light guide body 8. Further, respective LED elements of the LED array 7 on a left side relative to the center portion of the upper light guide body 8 are disposed symmetrically with the right-side LED elements.

Similarly, at a portion corresponding to the lower light guide body 9, four ultraviolet LED elements UV5, UV6, UV7, UV8, an infrared LED element IR3, a white LED element WL3, an ultraviolet LED element UV9, and a white LED element WL4 are arranged in the order mentioned from the center portion of the drawing to the right thereof along a lower side reference line L2 extending in the longitudinal direction of the lower light guide body 9. Further, respective LED elements of the LED array 7 on the left side relative to the center portion of the lower light guide body 9 are disposed symmetrically with the right-side LED elements.

The above white LEDs, infrared LEDs, and ultraviolet LEDs are connected to the drive circuit mounted on the main board 5 and can emit light independently of each other. The camera 13 is constituted by an imaging optical system (not illustrated), an imaging element (not illustrated), and the like, while in the object reading device 1 according to the embodiment, an infrared cut-off filter and an ultraviolet cut-off filter are not provided since it is necessary to read infrared light and ultraviolet light diffused and reflected by a surface of the driver's license 4 or the like.

The object reading device 1 picks up a visible light image by using the camera 13 while lighting the white LEDs in a state where the driver's license 4 is placed on the glass plate 3, then picks up an infrared image by using the camera 13 while lighting the infrared LEDs, and picks up an ultraviolet image while lighting the ultraviolet LEDs. The visible light image, infrared image, and ultraviolet image are output to the object verification device 100.

### First Embodiment

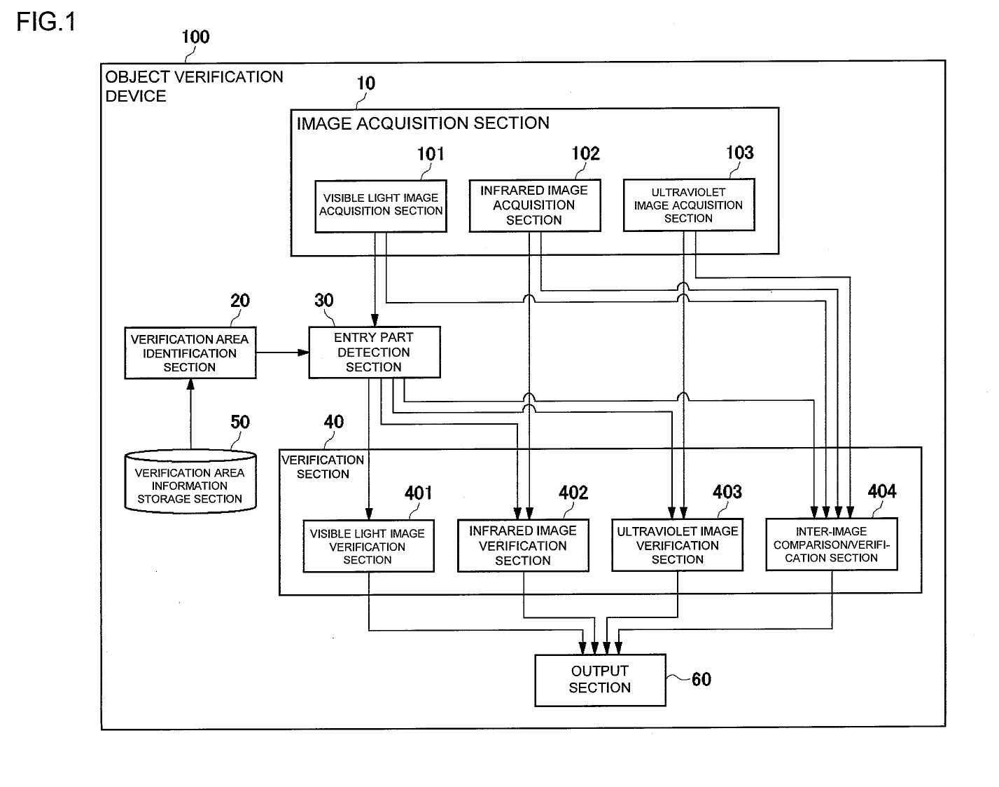

FIG. 1 is a block diagram illustrating a configuration of the object verification device according to a first embodiment. The object verification device 100 includes an image acquisition section 10, a verification area identification section 20, an entry part detection section 30, a verification section 40, a verification area information storage section 50, and an output section 60.

The image acquisition section 10 acquires an image from the object reading device 1. The image acquisition section 10 includes a visible light image acquisition section 101, an infrared image acquisition section 102, and an ultraviolet image acquisition section 103. The visible light image acquisition section 101 acquires a visible light image output from the object reading device 1, infrared image acquisition section 102 acquires an infrared image output from the object reading device 1, and ultraviolet image acquisition section 103 acquires an ultraviolet image output from the object reading device 1. The infrared and ultraviolet images correspond to a “non-visible light image”. Although the object reading device 1 picks up ultraviolet light diffused and reflected by the surface of the driver's license 4 or the like by using the camera 13 as described above, the object reading device 1 may pick up fluorescence generated at the surface of the driver's license surface or the like due to ultraviolet ray irradiation. The fluorescence is generally visible light, so that the camera 13 picks up visible light in this case. However, the ultraviolet light as a primary light source irradiating the driver's license or the like is invisible, so that an image obtained by picking up the secondarily generated fluorescence is also included in the so-called “non-visible light image (ultraviolet image)”.

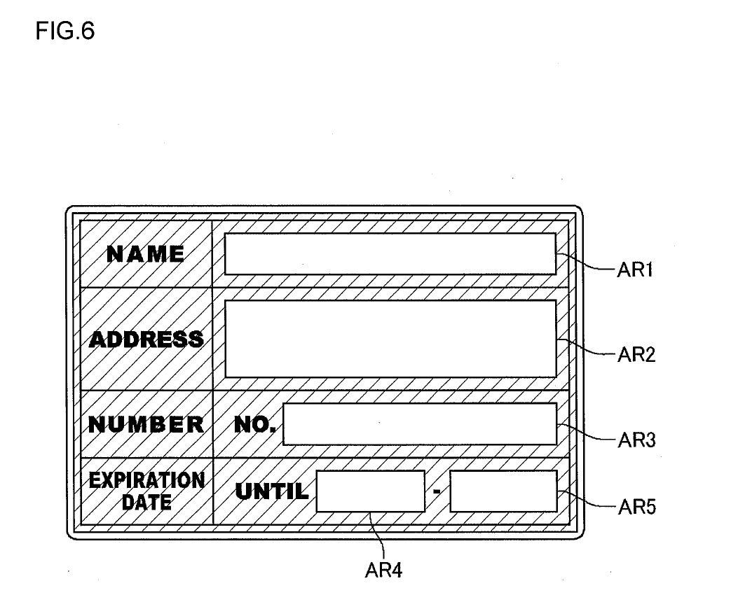

The verification area information storage section 50 stores information of fixed-form area in which fixed-form information of the driver's license is entered. FIG. 6 is a view illustrating a concrete example of verification area information stored in the verification area information storage section 50. A hatched area in FIG. 6 is the fixed-form area. The fixed-form area is an area in which ruled lines, items such as “NAME” and “ADDRESS”, and other entries such as “No.”, “UNTIL”, and “-” are entered. A non-hatched area in FIG. 6, i.e., the area other than the fixed-form area is a unique area in which unique information is entered. As illustrated in FIG. 6, the unique area is divided into five areas: area AR1 in which a name is entered; area AR2 in which an address is entered; area AR3 in which a number is entered; area AR4 in which an expiration year is entered; and area AR5 in which an expiration month is entered.

The verification area identification section 20 identifies, based on information of the fixed-form area stored in the verification area information storage section 50, the area other than the fixed-form area as a verification area. The verification area corresponds to the unique area in which the unique information is entered. The verification area identification section 20 identifies the plurality of independent unique areas AR1 to AR5 as the verification areas, respectively, and outputs information thereof to the entry part detection section 30.

The entry part detection section 30 acquires the visible light image from the visible light image acquisition section 101. The entry part detection section 30 detects, from the visible light image, a part in which there is any entry in the verification area identified by the verification area identification section 20. In the verification area in the driver's license in the present embodiment, characters or digits (hereinafter, referred to merely as “characters”) are entered in black color with white background. The entry part detection section 30 digitizes the verification area of the visible light image to recognize a set of black pixels forming one character and detect a rectangular part including the one character (or digit) as an entry part.

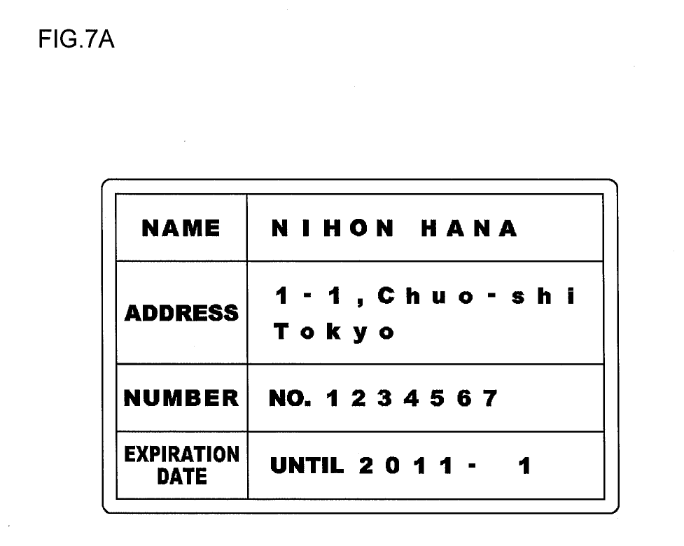

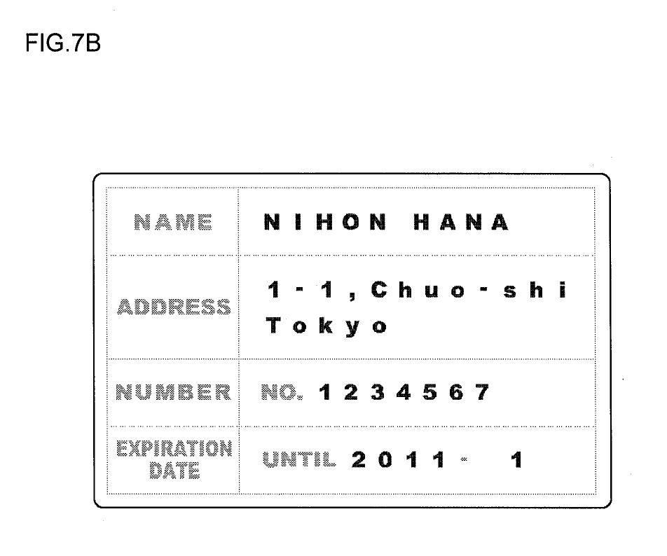

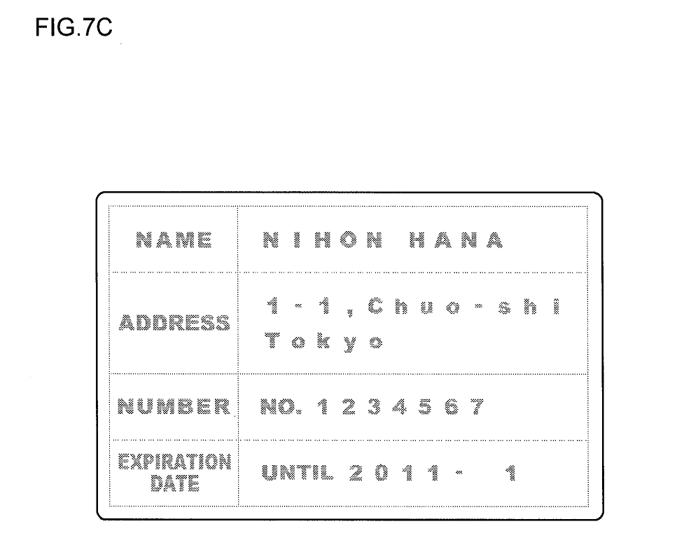

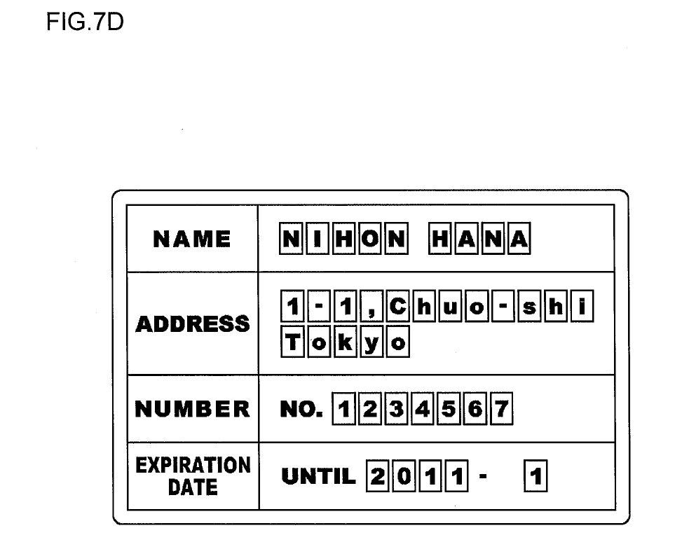

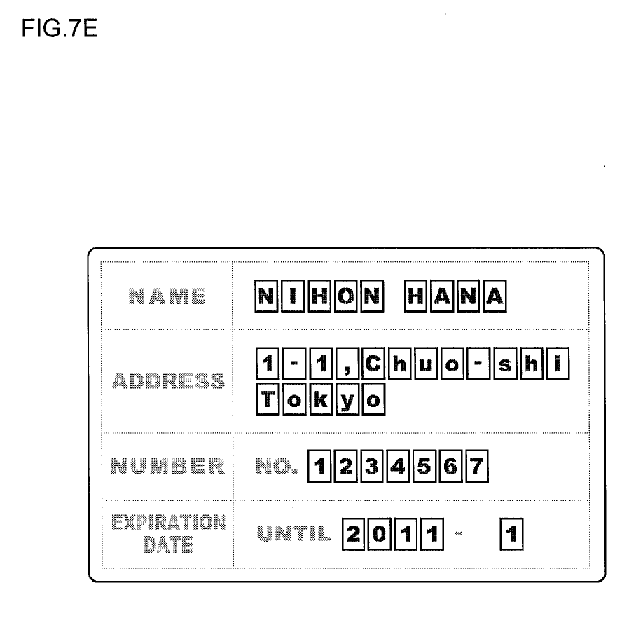

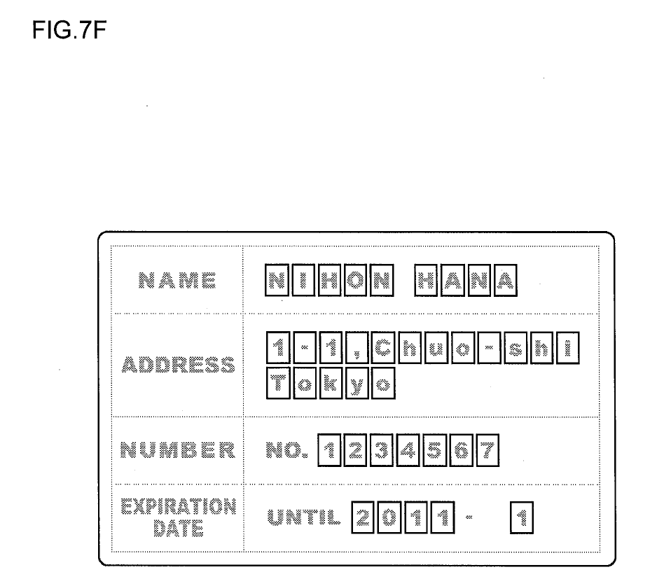

FIG. 7A is a view illustrating a concrete example of the visible light image, and FIG. 7D is a view illustrating a result obtained by detecting the entry part from the visible light image. In FIG. 7D, a framed part is a part detected as the entry part by the entry part detection section 30. As illustrated, the entry part is detected per one character basis, so that a plurality of the entry parts is detected from one object to be verified. Further, each verification area includes the plurality of the entry parts (only one entry part may be detected from the area AR5 of “expiration month”).

The verification section 40 verifies authenticity of the driver's license. The verification section 40 includes a visible light image verification section 401, an infrared image verification section 402, an ultraviolet image verification section 403, and an inter-image comparison/verification section 404. The visible light image verification section 401 acquires the visible light image from the visible light image acquisition section 101, further acquires information of the entry part from the entry part detection section 30, and mutually compares the plurality of entry parts of the visible light image to verify the authenticity. The infrared image verification section 402 acquires the infrared image from the infrared image acquisition section 102, further acquires information of the entry part from the entry part detection section 30, and mutually compares the plurality of entry parts of the infrared image to verify the authenticity. The ultraviolet image verification section 403 acquires the ultraviolet image from the ultraviolet image acquisition section 103, further acquires information of the entry part from the entry part detection section 30, and mutually compares the plurality of entry parts of the ultraviolet image to verify the authenticity. That is, the visible light image verification section 401, infrared image verification section 402, and ultraviolet image verification section 403 perform intra-image verification using the visible light image, infrared image, and ultraviolet image, respectively.

The inter-image comparison/verification section 404 acquires the visible light image from the visible light image acquisition section 101, acquires the infrared image from the infrared image acquisition section 102, acquires the ultraviolet image from the ultraviolet image acquisition section 103, and acquires information of the entry part from the entry part detection section 30. The inter-image comparison/verification section 404 compares mutually corresponding entry parts between the visible light image, infrared image, and ultraviolet image to verify the authenticity. That is, the inter-image comparison/verification section 404 performs inter-image verification between the visible light image, infrared image, and ultraviolet image.

As described above, in the present embodiment, the entry part is detected from the visible light image, and a result of the detection is used in the visible light image verification section 401, infrared image verification section 402, ultraviolet image verification section 403, and inter-image comparison/verification section 404. Thus, the entry part to be verified in the visible light image verification section 401, infrared image verification section 402, ultraviolet image verification section 403, and inter-image comparison/verification section 404 is common to all the sections 401 to 404. That is, for example, a part that is detected as the entry part from the visible light image but not detected from the ultraviolet image is treated as the entry part in the verification of the ultraviolet image.

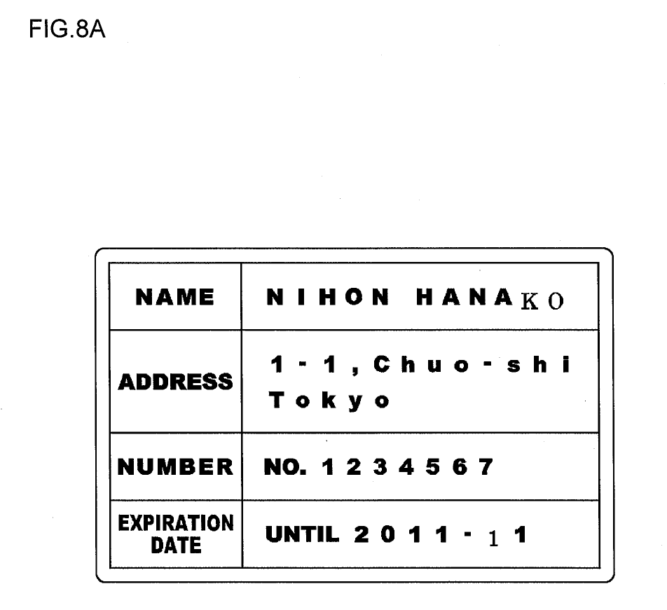

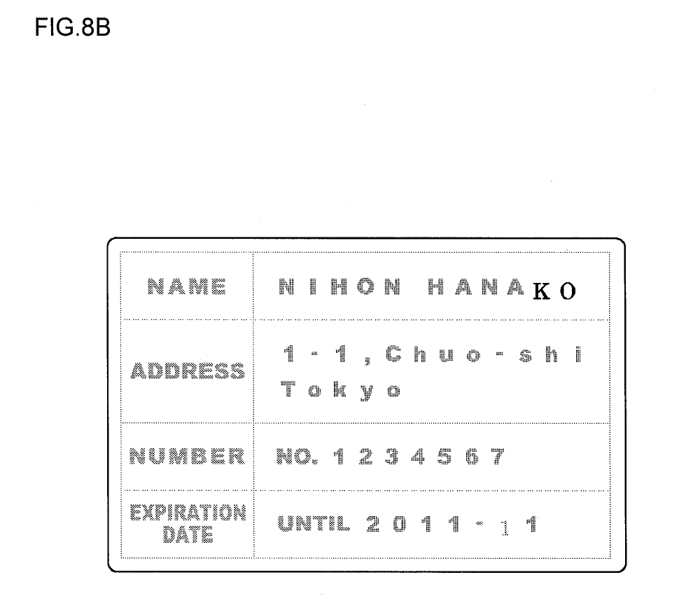

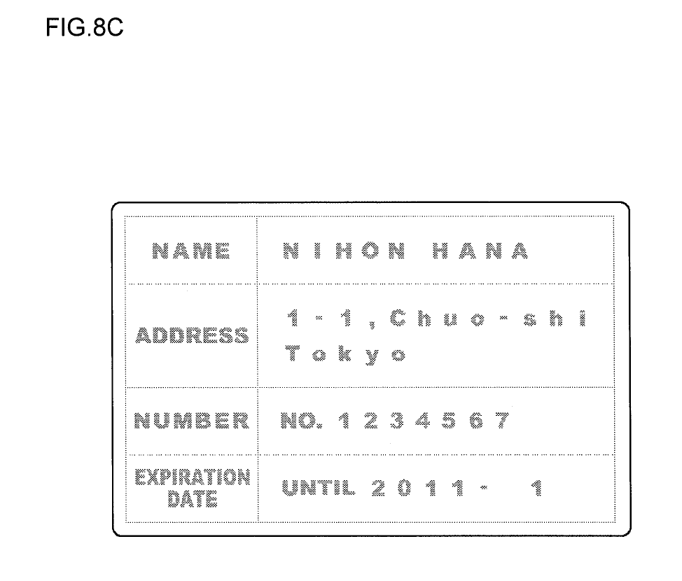

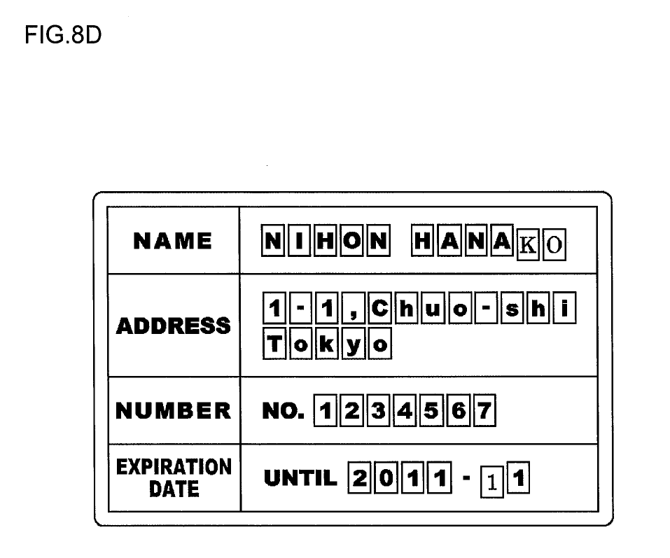

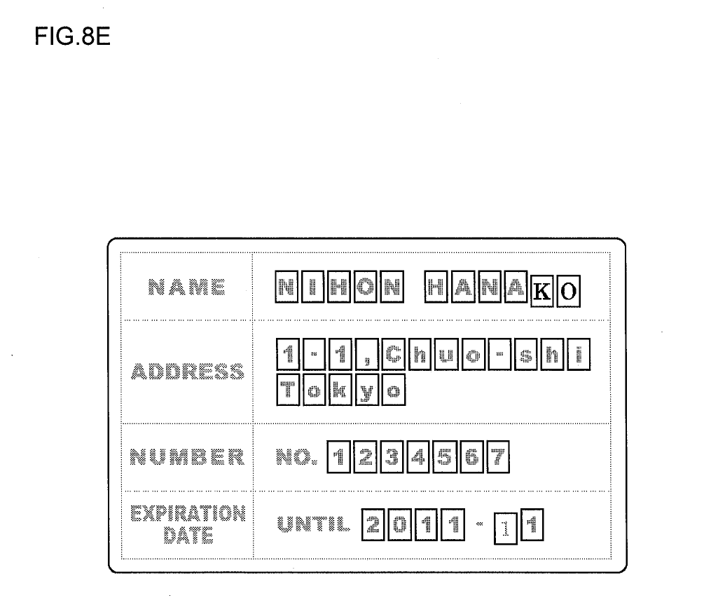

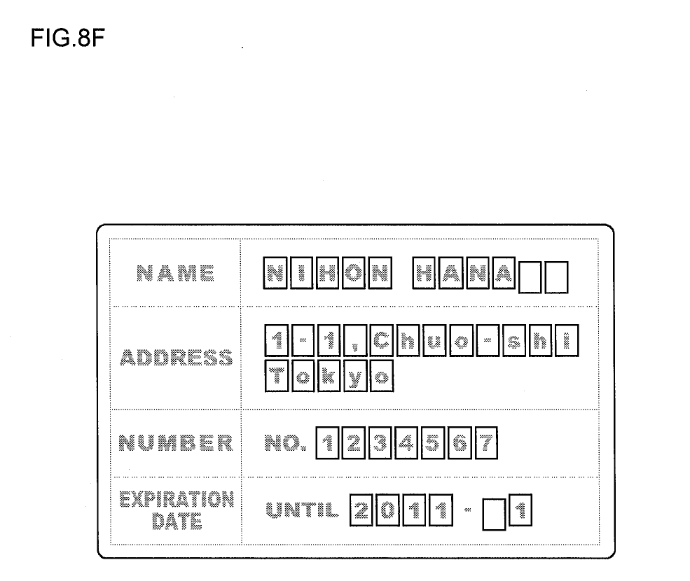

FIGS. 7A to 7F are views each illustrating an image of an authentic driver's license. FIGS. 8A to 8F are views each illustrating an image of a driver's license falsified based on the driver's license of FIGS. 7A to 7F. FIGS. 7A and 8A are views each illustrating the visible light image, FIGS. 7B and 8B are views each illustrating the infrared image, FIGS. 7C and 8C are views each illustrating the ultraviolet image, FIGS. 7D and 8D are views each illustrating a result obtained by detecting the entry part from the verification area of the visible light image, FIGS. 7E and 8E are views in which the entry part detected from the visible light image to the verification area of the infrared image, and FIGS. 7F and 8F are views in which the entry part detected from the visible light image to the verification area of the ultraviolet image.

The intra-image verification in each of the visible light image verification section 401, infrared image verification section 402, and ultraviolet image verification section 403 will be described. The visible light image verification section 401, infrared image verification section 402, and ultraviolet image verification section 403 each perform, as the intra-image verification, font verification, character luminance verification, character luminance difference verification, and background luminance verification. In the font verification, character recognition is performed for the entry part detected by the entry part detection section 30 to determine a font of the recognized character. Then, the fonts of the all characters recognized in the visible light image, infrared image, and violet image are mutually compared.

For example, when the character recognition is performed, in terms of font, for the entry parts in the authentic driver's license of FIG. 7D, all the characters are determined to be Gothic. Here, assume that characters “KO” is fraudulently added to the end of the name and a digit “1” is fraudulently added to the expiration month in the authentic driver's license. In this case, when the font of the “KO” and “1” are Century as illustrated in FIG. 8D, it is determined that there is any fraudulent entry in the font verification for the visible light image.

In the character luminance verification, a luminance of a character part is calculated for the entry part detected by the entry part detection section 30. More specifically, a histogram of each entry part is created, and a peak of the character part is calculated. Then, it is determined, in each of the visible light image, infrared image, and ultraviolet image, whether or not a difference among the peaks of the character parts in the histograms of the plurality of detected entry parts falls within a predetermined threshold.

For example, when the luminance of the character part of each entry part is calculated in the authentic driver's license of FIG. 7E, the luminance of the original character is at an intermediate level. Here, assume that characters “KO” is fraudulently added to the end of the name and a digit “1” is fraudulently added to the expiration month in the authentic driver's license. In this case, when the luminance of characters of the “KO” is lower (darker) than the original character due to a difference in ink type and, conversely, the luminance of character of “1” is higher (lighter) than the original character as illustrated in FIGS. 8B and 8E, a difference between the luminance of the fraudulently added character and luminance of the original character is equal to or more than the threshold, with the result that it is determined that there is any fraudulent entry in the character luminance verification for infrared image.

As illustrated in FIG. 8C, in the ultraviolet image, the original characters appear light, while the fraudulently added “KO” and “1” do not appear due to a difference in ink type. However, in the present embodiment, the entry part detected from the visible light image is adopted also in the ultraviolet image as described above. Thus, as illustrated in FIG. 8F, also the fraudulently added parts corresponding to “KO” and “1” that do not appear in the ultraviolet image are regarded as the entry parts. Thus, when the entry parts corresponding to the parts to which the “KO” and “1” are fraudulently added are compared with the other original entry parts in the ultraviolet image, a difference in luminance occurs, whereby it is determined that there is any fraudulent entry.

In the character luminance difference verification, the same verification as the above-described character luminance verification is performed with the character luminance in the character luminance verification replaced by a luminance difference between the character luminance and background luminance. That is, in each of the visible light image, infrared image, and ultraviolet image, a difference between the peaks of the character part and background part in the histogram of each of the plurality of detected entry parts is calculated, and it is determined that there is any fraudulent entry when a difference among the differences between the peaks is equal to or more than a predetermined threshold.

In the background luminance verification, the same verification as the above-described character luminance verification is performed for a part (background) of the entry part other than the character part. Even when a fraudulently added character is printed in the same ink as the original character and thus the fraudulence cannot be detected in the character luminance verification, an image having a different background luminance from that of another unique area may be obtained in each of the visible light image, infrared image, and ultraviolet image. One example is a case where a character is fraudulently added to some unique area to which a tape is stuck or on which paint is applied. The background luminance verification is verification for detecting such falsification.

Next, the inter-image comparison/verification performed in the inter-image comparison/verification section 404 will be described. The inter-image comparison/verification section 404 performs, as the inter-image comparison/verification, character luminance comparison/verification, character luminance difference comparison/verification, and background luminance comparison/verification.

In the character luminance comparison/verification, a luminance difference between character parts of mutually corresponding entry parts in the visible light image, infrared image, and ultraviolet image is calculated, and the luminance differences of the character parts are compared between respective entry parts. In the example of FIGS. 8D and 8E, a luminance difference between the characters “HANA” in the visible light image and characters “HANA” in the infrared image is calculated, and then a luminance difference between the characters “KO” in the visible light image and characters “KO” in the infrared image is calculated. When the characters “HANA” and characters “KO” are printed in ink of the same type, the above luminance differences should be substantially the same. However, in the example of FIGS. 8D and 8E, the original characters “HANA” appear lighter in the infrared image than in the visible light image, while the characters “KO” are fraudulently added using ink different from that for the characters “HANA” and, as a result, have the similar luminance both in the infrared image and visible light image, that is, the luminance difference is small between the infrared image and visible light image. Thus, a difference between the luminance difference between the original characters “HANA” in the infrared image and those in the visible light image and luminance difference between the fraudulently added characters “KO” in the infrared image and those in the visible light image is comparatively large. This difference is compared with a threshold and whereby the fraudulent entry can be detected.

In the character luminance difference comparison/verification, the same verification as the above-described character luminance comparison/verification is performed with the character luminance in the character luminance comparison/verification replaced by a luminance difference between the character luminance and background luminance. That is, a difference among the luminance differences between the corresponding entry parts in the visible light image, infrared image, and ultraviolet image is calculated, and it is determined that there is any fraudulent entry when a difference among the differences between the peaks is equal to or more than a predetermined threshold.

In the background luminance comparison/verification, the same verification as the above-described character luminance comparison/verification is performed for a part (background) of the entry part other than the character part. Even when a fraudulently added character is printed in the same ink as the original character and thus the fraudulence cannot be detected in the character luminance comparison verification, an image having a different background luminance from that of another unique area may be obtained in each of the visible light image, infrared image, and ultraviolet image. One example is a case where a character is fraudulently added to some unique area to which a tape is stuck or on which paint is applied. The background luminance comparison/verification is verification for detecting such falsification.

The verification section 40 performs the above-described verifications in the visible light image verification section 401, infrared image verification section 402, ultraviolet image verification section 403, and inter-image comparison/verification section 404, respectively. When any fraudulent entry is detected in any of the verifications, it is determined that there is any fraudulence in the entry of the driver's license, and a result of the verification is output to the output section 60. The output section 60 outputs the verification result by a display or voice. When the object verification device 100 is incorporated in the object reading device 1, the output section 60 may be a lamp provided in the object reading device 1. That is, when a verification result indicating that there is any fraudulence is obtained, the lamp is lighted or flickered.

As described above, according to the first embodiment, the unique area of the driver's license in which the unique information is entered is set as the verification area, a plurality of the entry parts are then detected from the verification area, and the plurality of detected entry parts are mutually compared, whereby presence/absence of a fraudulent entry is verified. Thus, even when the entry part in the verification area differs for each driver's license (for example, even when the number of characters constituting the name is three or four), the entry part can be reliably detected and subjected to comparison.

Further, in the first embodiment, the entry part detected in the visible light image is applied to the infrared image and ultraviolet image. This allows the fraudulence to be detected even when only the fraudulent entry appears in the infrared image or only the fraudulent entry does not appear in the ultraviolet image.

In the first embodiment, the inter-image verification performed in the inter-image comparison/verification section 404 may be omitted. Further, any of the visible light image verification section, infrared image verification section, and ultraviolet image verification section may be omitted.

Further, although information of the fixed-form area of the driver's license is stored in the verification area information storage section 50 in the first embodiment, information of the unique area of the driver's license may be stored in place of the fixed-form area. In this case, the verification area identification section 20 identifies the unique information stored in the verification area information storage section 50 as the verification area. Further, information of the fixed-form area or unique area of a certificate other than the driver's license may be stored in the verification area information storage section 50.

Further, the verification area identification section 20 may identify the verification area based on not the information stored in the verification area information storage section 50, but a user's input operation. In this case, the verification area information storage section 50 can be omitted. By adopting a configuration in which the user can arbitrarily specify the verification area, he or she can perform verification for an arbitrary object to be verified. Further, when the ink type used for both the unique area and fixed-form area is the same, it is necessary to identify the verification area, so that, in this case, the verification area identification section 20 and verification area information storage section 50 can be omitted.

### Second Embodiment

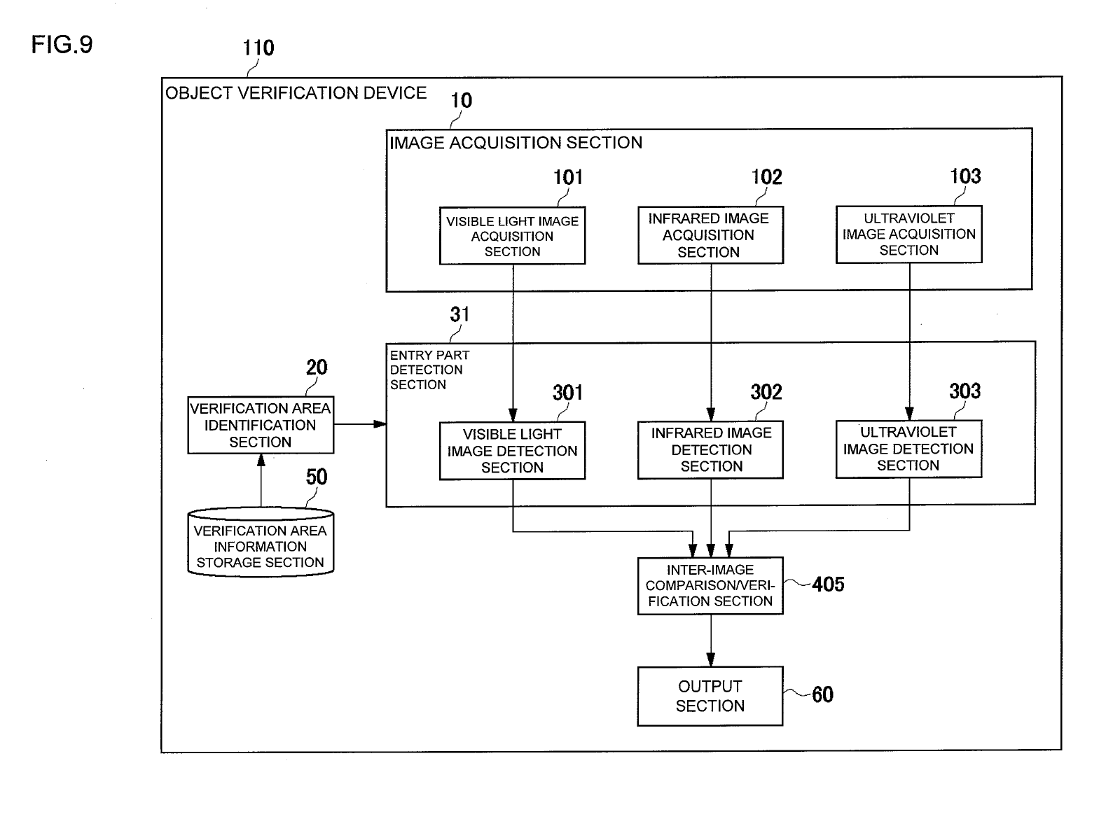

FIG. 9 is a block diagram illustrating a configuration of an object verification device according to a second embodiment. The same parts of an object verification device 110 according to the second embodiment as those of the object verification device 100 according to the first embodiment are denoted by the same reference numerals as those of the first embodiment, and descriptions thereof are appropriately omitted.

The object verification device 110 according to the present embodiment includes an image acquisition section 10, a verification area identification section 20, an entry part detection section 31, an inter-image comparison/verification section 41, a verification area information storage section 50, and an output section 60. As in the first embodiment, the image acquisition section 10 includes a visible light image acquisition section 101, an infrared image acquisition section 102, and an ultraviolet image acquisition section 103. The entry part detection section 31 of the object verification device 110 according to the present embodiment includes a visible light image detection section 301, an infrared image detection section 302, and an ultraviolet image detection section 303.

The visible light image detection section 301 detects the entry part from the verification area which is included in the visible light image acquired by the visible light image acquisition section 101 and which is identified by the verification area identification section 20. The infrared image detection section 302 detects the entry part from the verification area which is included in the infrared image acquired by the infrared image acquisition section 102 and which is identified by the verification area identification section 20. The ultraviolet image detection section 303 detects the entry part from the verification area which is included in the ultraviolet image acquired by the ultraviolet image acquisition section 103 and which is identified by the verification area identification section 20. That is, in the present embodiment, the entry part is detected from each of the visible light image, infrared image, and ultraviolet image.

The inter-image comparison/verification section 41 inputs thereto images of the entry parts detected by the respective visible light image detection section 301, infrared image detection section 302, and ultraviolet image detection section 303. The inter-image comparison/verification section 41 compares the images of the entry parts to verify authenticity.

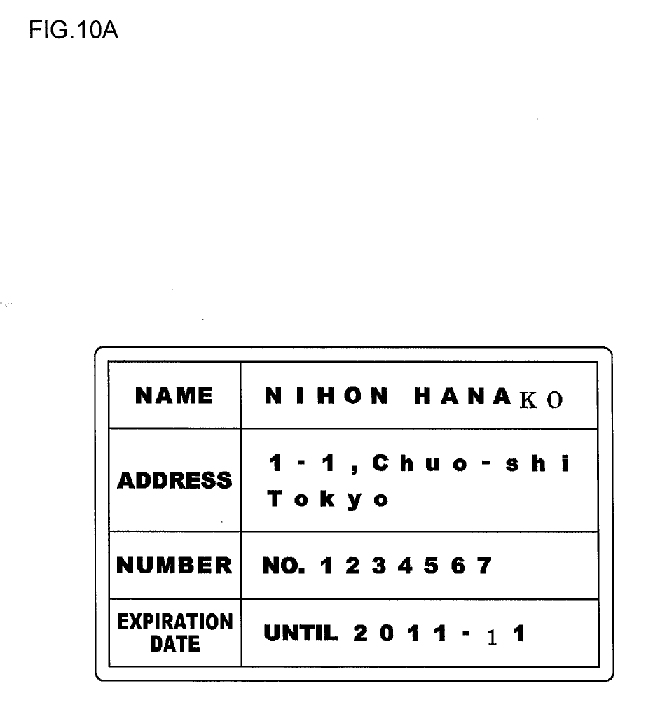

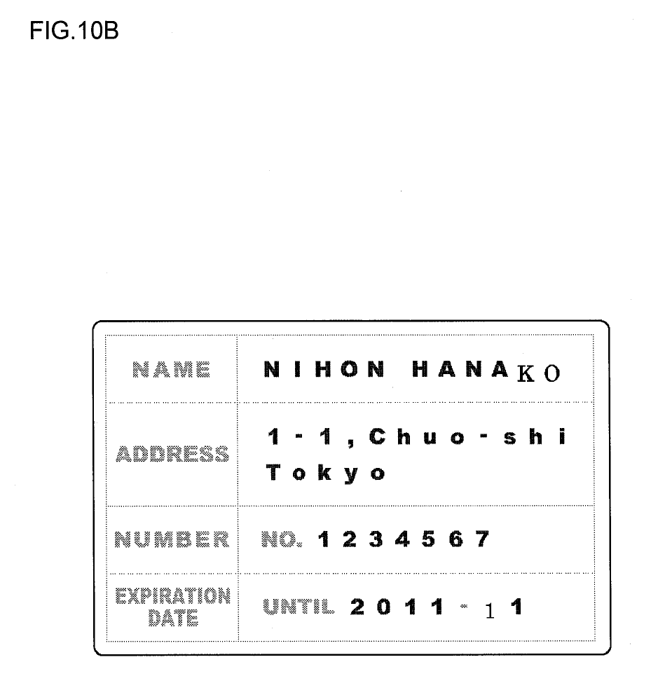

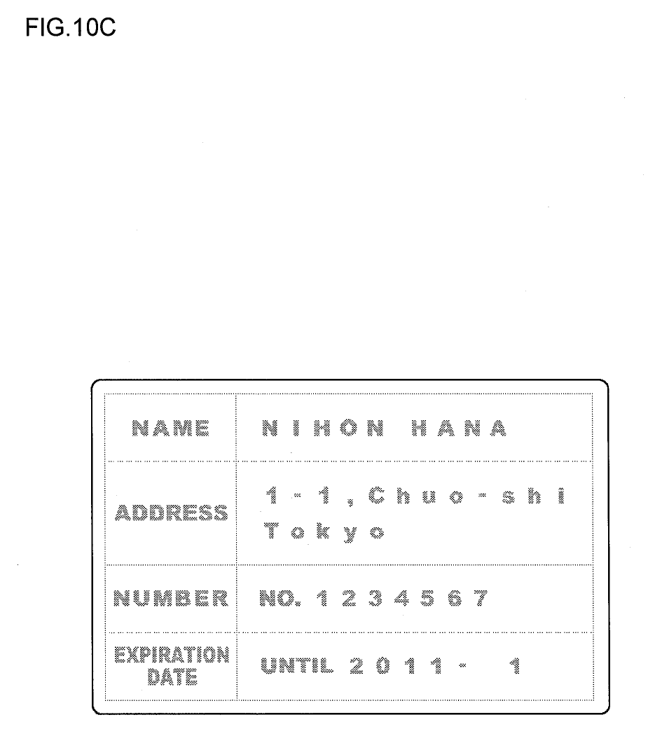

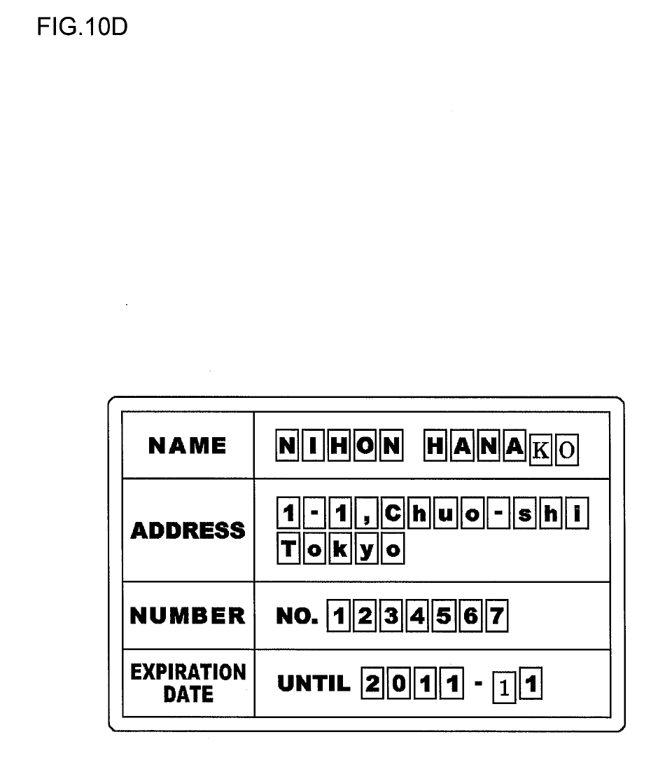

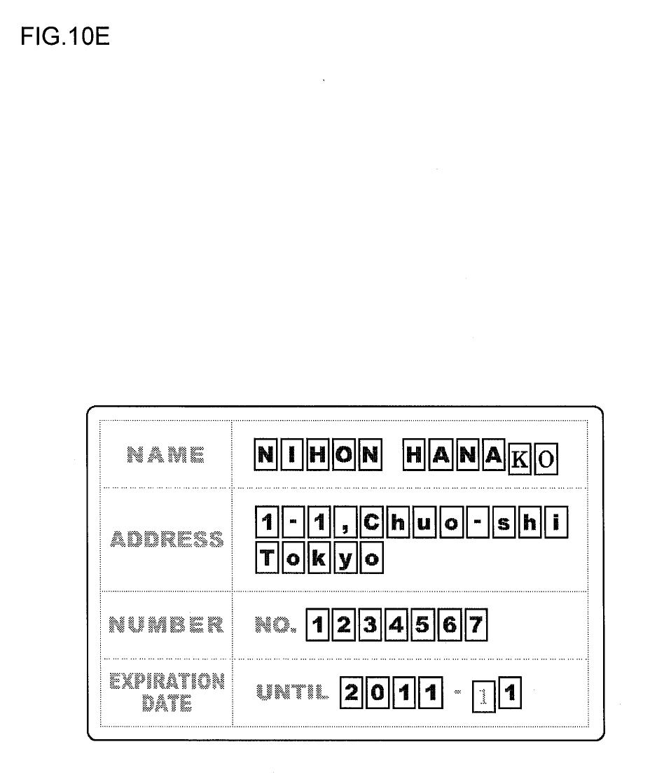

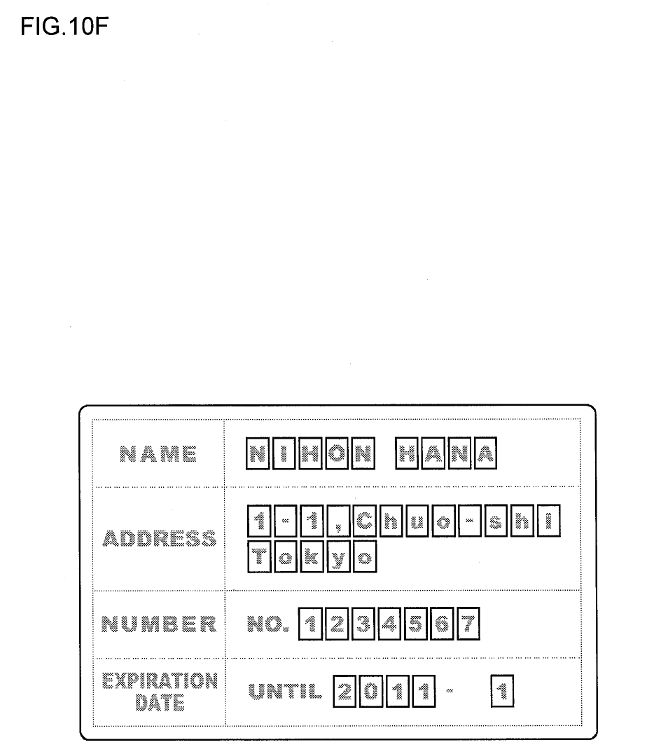

FIGS. 10A to 10F are views each illustrating an image obtained by picking up an image of a falsified driver's license as in the examples of FIGS. 8A to 8F. That is, the characters “KO” are fraudulently added to the end of the original characters “HANA” in the name field, and the character “1” is fraudulently added before the original character “1” in the field of expiration month. FIG. 10A is a visible light image, and FIG. 10D is a result obtained by detecting the entry part from the visible light image; FIG. 10B is an infrared image, and FIG. 10E is a result obtained by detecting the entry part from the infrared image; FIG. 10C is an ultraviolet image, and FIG. 10F is a result obtained by detecting the entry part from the ultraviolet image.

As in the example of FIGS. 8A to 8F, also in the examples of FIGS. 10A to 10F, the fraudulently added characters “KO” and “1” do not appear in the ultraviolet image. When comparing FIGS. 10A to 10F to FIGS. 8A to 8F, in FIGS. 8A to 8F of the first embodiment, the entry part detected from the visible light image is applied to the ultraviolet image, so that the parts corresponding to the added “KO” and “1” are detected as the entry parts in the ultraviolet image; on the other hand, in FIGS. 10A to 10F of the present embodiment, the entry part is detected from the ultraviolet image, so that the parts corresponding to the added “KO” and “1” are not detected as the entry parts. As a result, as illustrated in FIG. 10D to 10F, arrangement of the entry part differs between the visible light image, infrared image, and ultraviolet image.

The inter-image comparison/verification section 41 performs, as the inter-image comparison/verification, arrangement comparison/verification, character luminance comparison/verification, character luminance difference comparison verification, and background luminance comparison/verification. In the arrangement comparison/verification, arrangement of the entry parts in the visible light image, arrangement of the entry parts in the infrared image, and arrangement of the entry parts in the ultraviolet image are mutually compared. As described above, as illustrated in FIGS. 10A and 10B, the fraudulently added characters “KO” and “1” appear in the visible light image and infrared image, so that corresponding parts are detected as the entry parts by the entry part detection section 30 as illustrated in FIGS. 10D and 10E. However, as illustrated in FIG. 10C, the fraudulently added characters “KO” and “1” do not appear in the ultraviolet image, so that the corresponding parts are not detected as the entry parts as illustrated in FIG. 10F. Thus, by mutually comparing the entry part between FIGS. 10D, 10E, and 10F, in terms of arrangement, a difference occurs in the parts corresponding to the characters “KO” and “1”, whereby it can be determined that there is any fraudulent entry.

The character luminance comparison/verification, character luminance difference comparison verification, and background luminance comparison/verification are the same as those in the first embodiment, so descriptions thereof are omitted here. When the entry part to be compared between the images is absent, the comparison with respect to the entry part is not performed. When it is determined in the inter-image comparison/verification section 41 that there is any fraudulence in any of the above comparison/verification processing, a result indicating presence of the fraudulence is output to the output section 60.

As described above, according to the second embodiment, the entry part is detected in each of the visible light image, infrared image, and ultraviolet image. Thus, when the fraudulently added character does not appear in the infrared image or ultraviolet image due to a difference in ink type although the original character appears therein, the arrangement of the entry parts is compared between the images, whereby the fraudulent entry can be detected.

In the second embodiment, only the inter-image verification is performed, and the intra-image verification is not performed. Accordingly, it is not always necessary that the verification area identification section 20 identifies the verification area and that the entry part detection section 31 detects the entry part only from the verification area. Thus, in the second embodiment, the entry part detection section 31 may verify the entry parts in the whole area within the image with the verification area identification section 20 and verification area information storage section 50 omitted. Further, after dividing the image into the unique area and fixed-form area, the verification area identification section 20 may verify presence/absence of the falsification in the fixed-form area by comparing the detected fixed-form area with previously stored fixed-form information.

Though the currently considerable preferred embodiments of the present invention have been described, various modifications may be made to the embodiment, and all such modifications within the sprit and scope of the invention are included in the appended claims.

### INDUSTRIAL APPLICABILITY

The present invention can detect a fraudulent entry in an arbitrary area of an object without requiring a certification mark applied by a special material and is thus useful as an object verification device that verifies authenticity of an object.

### REFERENCE SIGNS LIST

1 Object reading device
2 Housing
3 Glass plate
4 Driver's license
4a Surface to be read
5 Main board
6 Illumination board
7 LED array
8 Upper light guide body
9 Lower light guide body
13 Camera
14 Reflecting mirror
16 Spacer
100 Object verification device
10 Image acquisition section
101 Visible light image acquisition section
102 Infrared image acquisition section
103 Ultraviolet image acquisition section
20 Verification area identification section
30 Entry part detection section
40 Verification section
401 Visible light image verification section
402 Infrared image verification section
403 Ultraviolet image verification section
404 Inter-image comparison/verification section
50 Verification area information storage section
60 Output section
110 Object verification device
31 Entry part detection section
301 Visible light image detection section
302 Infrared image detection section
303 Ultraviolet image detection section
41 Inter-image comparison/verification section
1000 Object verification system

1. An object verification device that verifies authenticity of an object, comprising:
an image acquisition section that acquires an image of the object;
a verification area identification section that identifies a verification area of the object for which authenticity is verified;
an entry part detection section that detects a plurality of entry parts within the verification area in the image; and
a verification section that verifies authenticity of the object by mutually comparing the plurality of entry parts in the image.

2. The object verification device according to claim 1, wherein
the image acquisition section includes a visible light image acquisition section that acquires a visible light image of the object and a non-visible light image acquisition section that acquires a non-visible light image of the object, wherein
the entry part detection section detects the entry part from the visible light image, and
the verification section verifies authenticity of the object by mutually comparing the plurality of entry parts in the non-visible light image.

3. The object verification device according to claim 1, further comprising a verification area information storage section that stores a unique area within the object in which unique information is entered, wherein
the verification area identification section identifies, as the verification area, the unique area stored in the verification area information storage section.

4. The object verification device according to claim 1, further comprising a verification area information storage section that stores a fixed-form area within the object in which fixed-form information is entered, wherein
the verification area identification section identifies, as the verification area, an area other than the fixed-form area stored in the verification area information storage section.

5. The object verification device according to claim 1, wherein
the verification section verifies authenticity of the object by comparing, between the plurality of detected entry parts, a luminance value of entry content in each entry part.

6. The object verification device according to claim 1, wherein
the verification section verifies authenticity of the object by comparing, between the plurality of detected entry parts, a luminance difference between entry content and a background in each entry part.

7. The object verification device according to claim 1, wherein
the verification section verifies authenticity of the object by comparing, between the plurality of detected entry parts, a character font of entry content in each entry part.

8. An object verification device that verifies authenticity of an object, comprising:
a visible light image acquisition section that acquires a visible light image of the object;
a non-visible light image acquisition section that acquires a non-visible light image of the object;
a visible light image entry part detection section that detects, as a visible light image entry part, each of a plurality of entry parts of the object in the visible light image;
a non-visible light image entry part detection section that detects, as a non-visible light image entry part, each of a plurality of entry parts of the object in the non-visible light image; and
a verification section that verifies authenticity of the object by mutually comparing the plurality of detected visible light image entry parts and non-visible light image entry parts.

9. The object verification device according to claim 8, further comprising a verification area identification section that identifies a verification area of the object for which authenticity is verified, wherein
the visible light image entry part detection section detects the plurality of visible light image entry parts in the identified verification area in the visible light image, and
the non-visible light image entry part detection section detects the plurality of visible light image entry parts in the identified verification area in the non-visible light image.

10. The object verification device according to claim 8, wherein
the verification section verifies authenticity of the object by comparing a luminance difference between the visible light image entry part of the visible light image and non-visible light image entry part of the non-visible light image corresponding to the visible light image entry part for a plurality of combinations of the visible light image entry part and the non-visible light image entry part.

11. The object verification device according to claim 8, wherein
the verification section verifies authenticity of the object by comparing arrangement of the plurality of visible light image entry parts of the visible light image and arrangement of the plurality of non-visible light image entry parts of the non-visible light image.

12. An object verification program allowing, when executed by a computer provided in an object verification device that verifies authenticity of an object to function as:
an image acquisition section that acquires an image of the object;
a verification area identification section that identifies a verification area of the object for which authenticity is verified;
an image entry part detection section that detects, as an image entry part, each of a plurality of entry parts within the verification area in the image; and
a verification section that verifies authenticity of the object by mutually comparing the plurality of detected image entry parts.

13. An object verification program allowing, when executed by a computer provided in an object verification device that verifies authenticity of an object to function as:
a visible light image acquisition section that acquires a visible light image of the object;
a non-visible light image acquisition section that acquires a non-visible light image of the object;
a visible light image entry part detection section that detects, as a visible light image entry part, an entry part in the visible light image;
a non-visible light image entry part detection section that detects, as a non-visible light image entry part, an entry part of the object in the non-visible light image; and
a verification section that verifies authenticity of the object by mutually comparing the detected visible light image entry part and non-visible light image entry part.

14. An object verification method that verifies authenticity of an object, comprising:
an image acquisition step of acquiring an image of the object;
a verification area identification step of identifying a verification area of the object for which authenticity is verified;
an image entry part detection step of detecting, as an image entry part, each of a plurality of entry parts within the verification area in the image; and
a verification step of verifying authenticity of the object by mutually comparing the plurality of detected image entry parts.

15. An object verification method that verifies authenticity of an object, comprising:
a visible light image acquisition step of acquiring a visible light image of the object;
a non-visible light image acquisition step of acquiring a non-visible light image of the object;
a visible light image entry part detection step of detecting, as a visible light image entry part, an entry part in the visible light image;
a non-visible light image entry part detection step of detecting, as a non-visible light image entry part, an entry part of the object in the non-visible light image; and
a verification step of verifying authenticity of the object by mutually comparing the detected visible light image entry part and non-visible light image entry part.

16. The object verification device according to claim 2, further comprising a verification area information storage section that stores a unique area within the object in which unique information is entered, wherein
the verification area identification section identifies, as the verification area, the unique area stored in the verification area information storage section.

17. The object verification device according to claim 2, further comprising a verification area information storage section that stores a fixed-form area within the object in which fixed-form information is entered, wherein
the verification area identification section identifies, as the verification area, an area other than the fixed-form area stored in the verification area information storage section.

18. The object verification device according to claim 2, wherein
the verification section verifies authenticity of the object by comparing, between the plurality of detected entry parts, a luminance value of entry content in each entry part.

19. The object verification device according to claim 2, wherein
the verification section verifies authenticity of the object by comparing, between the plurality of detected entry parts, a luminance difference between entry content and a background in each entry part.

20. The object verification device according to claim 2, wherein
the verification section verifies authenticity of the object by comparing, between the plurality of detected entry parts, a character font of entry content in each entry part.
